(19) United States
(12) Patent Application Publication
(10) Pub. No.: US 2011/0102285 A1
(43) Pub. Date: May 5, 2011

(54) PORTABLE WIRELESS DEVICE

(75) Inventors: Tomoaki Nishikido, Miyagi (JP); Hiroyuki Uno, Miyagi (JP); Masashi Koshi, Miyagi (JP); Yoshio Koyanagi, Kanagawa (JP); Kenya Nagano, Miyagi (JP)

(73) Assignee: PANASONIC CORPORATION, Osaka (JP)

(21) Appl. No.: 12/999,012

(22) PCT Filed: Feb. 23, 2009
(86) PCT No.: PCT/JP2009/000770

§ 371 Date: Dec. 14, 2010

(30) Foreign Application Priority Data
Jun. 17, 2008 (JP) 2008-157855

(51) Int. Cl. H01Q 9/28

(52) U.S. Cl. 343/795

(57) ABSTRACT

There is provided a foldable portable radio that can exhibit high phone call performance despite its low profile and small size.

An antenna element 14 to be placed in the vicinity of a first hinge element 13A is connected to a power feed unit. The first hinge element 13A has a hinge fixing unit 131 and a hinge rotating unit 132. The hinge fixing unit 131 is connected to a second radio circuit 17B of a lower circuit board 12A by way of a second matching circuit 16B. The hinge rotating unit 132 is placed while spaced apart from a ground pattern on an upper circuit board 11A by a predetermined interval and connected to an end of the ground pattern of the upper circuit board that is close to the first hinge element 13A. The antenna element 14 and the first hinge element 13A configure a first dipole antenna. The ground pattern of the upper circuit board 11A and a ground pattern of the lower circuit board 12A configure a second dipole antenna that takes the hinge element 13A as a power feed system. The first hinge element 13A acts as a ground in the first dipole antenna and also as a power feed system in the second dipole antenna.

### TECHNICAL FIELD

The present invention relates to a slim, foldable, portable radio that exhibits high phone call performance and that is compatible with a plurality of radio systems.

### BACKGROUND ART

Various portable radios such as portable phones, have hitherto been developed. In relation to the portable phones, various types of fordable portable phones each of which can perform re-closable round a hinge unit have been developed. In such a foldable portable phone, a display unit is placed in an upper enclosure. Due to limitations on space, a radio circuit is placed in a lower enclosure in many times. Further, in order to minimize a pass loss occurring between the radio circuit and an antenna, it is preferable to place the antenna in the vicinity of the radio circuit. Accordingly, in order to suppress the pass loss occurring between the radio circuit and the antenna, the antenna is often placed in the vicinity of the hinge unit of the lower enclosure. A known specific example of such a foldable portable phone is shown in; for instance, FIG. 10 (see; for example, Patent Document 1).

As shown in FIG. 10, a foldable portable phone 100 has a first antenna element 104 placed in an upper enclosure 101; a conductive element 105 that is placed in a lower enclosure 102 and that makes up a dipole antenna in conjunction with the first antenna element 104; a second antenna element 106 that makes up a monopole antenna placed in the lower enclosure 102 in the vicinity of a hinge unit 103; a first power feed unit 107 disposed at one lateral end of the first antenna element 104; a second power feed unit 108 that is disposed at one lateral end of the second antenna element 106 opposing the first power feed unit 107 and that sends an unbalanced feed to the second antenna element 106; and a high frequency switch 109 that performs as appropriate selective switching between the first antenna element 104 and the second antenna element 106. In the drawing, reference numeral 110 designates a matching circuit; 111 designate a radio circuit; 112 designates a switch control unit; and 113 designates an open-close detector.

Incidentally, such a foldable portable phone is commonly used while the enclosure of the portable phone is gripped by hand. Therefore, it is preferable to place the antenna at a location where the influence of the hand, or the like, is minimum. However, in the foldable portable phone shown in FIG. 10, an electric current flowing through the lower enclosure is large; hence, gain deterioration which arises when the mobile phone is used while gripped by hand is large.

For this reason, a portable phone 200, such as that shown in FIG. 11, has also been developed (see; for instance, Patent Document 2).

The portable phone 200 has an upper enclosure 201 housing a first circuit board 204; a lower enclosure 202 that houses a second circuit board 205 to be electrically connected to the first circuit board 204 and that is joined to the upper enclosure 201 by a hinge unit 203; an antenna element 206 incorporated in the upper enclosure 201; a power feed unit 207 that is placed in the first circuit board 204 and electrically connected to the antenna element 206; and a coaxial line 208 that electrically connects the first circuit board 204 to the second circuit board 205. In the drawing, reference numeral 209 designates a radio circuit, and 210 designates a flexible cable.

Patent Document 1: JP-A-2004-229048

Patent Document 2: JP-A-2007-158915

### DISCLOSURE OF THE INVENTION

<Problem that the Invention is to Solve>

However, in relation to a portable radio, such as a portable phone, a recent tendency to place an emphasis on a design at the time of purchase of the portable phone has become stronger. In order to prevent impairment of the design, there is an increasing desire to minimize the chance of protrusion of an antenna to the outside from enclosures. When an attempt is made to reduce; for instance, the thickness of enclosures of, a related art portable phone shown in FIG. 11, the antenna element 206 and the hinge unit 203 come close to. each other. Therefore, an antenna characteristic is deteriorated as a result of the antenna element being joined to the hinge unit, and a power feed unit is placed in the upper enclosure having a display unit accounting a large proportion of the upper enclosure; therefore, a foot print increases.

In the portable phone shown in FIG. 11, gain deterioration which will arise when the portable phone is used while gripped by hand can be avoided. However, the upper enclosure 201 operates as a monopole antenna while the upper enclosure is taken as a ground. Therefore, an electric current flowing through the upper enclosure 201 is large, and a vertical polarized component is larger than a horizontal polarized component. As a consequence, in a state of phone call, the vertical polarized component becomes dominant, which often results in a gain drop during the phone call.

The present invention has been conceived in light of the situation and aims at providing a foldable portable radio that enables a simultaneous reduction in thickness and size of enclosures and that can exhibit high phone call performance.

### <Means for Solving the Problem>

A portable radio of the present invention includes: a first enclosure where a first circuit board is placed; a second enclosure where a second circuit board is placed; a first hinge that rotatably joins the first enclosure to the second enclosure and that exhibits a conductive characteristic; an antenna element that is placed in a vicinity of the first hinge and substantially in parallel to an axial direction of the first hinge; a first radio circuit and a second radio circuit placed on the second circuit board; and a power feed unit connected to the first radio circuit, wherein the antenna element is placed while spaced apart from the first hinge by a predetermined interval and that is electrically connected to the power feed unit; the first hinge has a first hinge unit and a second hinge unit and also a first joint unit that electrically connects the first hinge unit to the second hinge unit and that supports the first hinge unit and the second hinge unit in a rotatble manner; the first hinge unit is provided in the first enclosure and electrically connected to an end of the first circuit board close to the first hinge; the second hinge unit is provided in the second enclosure, is placed while spaced apart from a ground pattern on the second circuit board by a predetermined interval, and is electrically connected to the second radio circuit; the antenna element and the first hinge configure a first dipole antenna, and a ground pattern on the first circuit board, the first hinge, and the ground pattern on the second circuit board configure a second dipole antenna; and the first hinge is a ground in the first dipole antenna and acts also as a power feed system in the second dipole antenna for feeding electric power from the second circuit board to the first circuit board. By means of the configuration, the first hinge acts as the ground in the first dipole antenna, and the first hinge unit acts also as the power feed unit in the second dipole antenna. Therefore, the thickness and size of the enclosures can simultaneously be reduced. Further, the portable radio has a radiation characteristic in which principal polarized wave components of the two antennas intersect at right angles, and hence can exhibit high communication performance.

Moreover, it is desirable that the portable radio should include a first matching circuit for effecting impedance matching located between the antenna element and the power feed unit and that a ground of the first matching circuit should be electrically connected to the first hinge. By means of the configuration, the first hinge acts as the ground in the first dipole antenna, and the first hinge unit acts also as the power feed unit in the second dipole antenna. Therefore, the thickness and size of the enclosures can simultaneously be reduced. Further, the portable radio has a radiation characteristic in which principal polarized wave components of the two antennas intersect at right angles, and hence can exhibit high communication performance.

There may also be arranged in such a way that the first matching circuit has one end electrically connected to the antenna element and another end connected to a power feed unit that feeds electric power from the first radio circuit of the second circuit board; that a second matching circuit has one end electrically connected to the second hinge unit and another end electrically connected to the second radio circuit of the second circuit board; that the first radio circuit conforms to a first frequency which is an operating frequency of a first antenna; and that the second radio circuit conforms to a second frequency which is an operating frequency of a second antenna. By means of the configuration, the portable radio can exhibit, by use of different frequencies, a superior antenna characteristic in which the principal polarized wave components of the two antennas intersect at right angles.

Further, it is preferable that the portable radio should further include at least one of a first filter and a second filter which shuts off a resonance frequency of the first antenna and a third filter which shuts off a resonance frequency of the second antenna; that the first filter should have one end electrically connected to the first hinge unit and another end electrically connected to an end of the first circuit board that is close to the first hinge; that the second filter should be placed on the second circuit board and has one end electrically connected to the second hinge unit and another end electrically connected to the second matching circuit of the second circuit board; and that the third filter should have one end electrically connected to the first hinge unit and another end electrically connected to the first matching circuit. The configuration can prevent flow of a signal of the dipole antenna in the hinge from flowing to the circuit boards in the first and second enclosures that act as a portion of the other dipole antenna. Therefore, the two antennas can simultaneously operate by use of different frequencies and also exhibit superior antenna characteristics in which their principal polarized wave components intersect at right angles.

There may also be a configuration in which the power feed unit is electrically connected to the radio circuit placed on either the first circuit board or the second circuit board by way of a coaxial line; and that an exterior conductor of the coaxial line electrically connects the first hinge unit to a ground of the first or second circuit board. By means of the configuration, the first hinge acts as the ground in the first dipole antenna, and the first hinge unit acts also as the power feed unit in the second dipole antenna. Therefore, the thickness and size of the enclosures can simultaneously be reduced. Further, the portable radio has a radiation characteristic in which principal polarized wave components of the two antennas intersect at right angles, and hence can exhibit high communication performance.

There may also be a configuration in which the portable radio further includes a high frequency switch which is electrically connected to the second matching circuit and the power feed unit for switching between the first antenna and the second antenna. The configuration makes it possible to switch between a plurality of antennas having different polarized waves and exhibit high communication performance.

There may also be a configuration in which an overlap between the antenna element and the first hinge in their longitudinal directions is about one-half of a length of the antenna element or less. The configuration lessens electromagnetic coupling between the antenna element and the first hinge, so that deterioration of the communication characteristic can be prevented.

A portable radio of the present invention also includes: a first enclosure; a second enclosure; a first hinge; and a second hinge that joins the first enclosure to the second enclosure so as to be rotatable around another axis orthogonal to an axis of the first hinge and that exhibits an electrical conductive characteristic, wherein an antenna element is placed while spaced apart from the first hinge by a predetermined interval and electrically connected to a power feed unit; the second hinge has a third hinge unit, a fourth hinge unit, and a second joint unit that electrically connects the third hinge unit to the fourth hinge unit and that supports the third hinge unit and the fourth hinge unit in a rotatable manner; a first hinge unit is placed in the first enclosure and connected to the third hinge unit, and the fourth hinge unit is electrically connected to an end of a first circuit board that is close to the first hinge; a second hinge unit is placed in the second enclosure while spaced apart from a ground pattern on a second circuit board by a predetermined interval and electrically connected to a second radio circuit; the antenna element and the second hinge configure a first dipole antenna, a ground pattern of the first circuit board, the first hinge, the second hinge, and the ground pattern on the second circuit board configure a second dipole antenna; and the second hinge acts as a ground in the first antenna and acts also as, in the second antenna, a power feed system for feeding electric power from the second circuit board to the first circuit board. By means of the configuration, the second hinge acts as the ground in the first dipole antenna, and the first hinge unit acts as the power feed unit. Therefore, the thickness and size of the enclosures can simultaneously be reduced. Further, the portable radio has a radiation characteristic in which principal polarized wave components of the two antennas intersect at right angles, and hence can exhibit high communication performance.

It is also desirable that the portable radio should further include a first matching circuit that is interposed between the antenna element and the power feed unit for matching impedance, wherein a ground of the first matching circuit and the second hinge are electrically connected together. By means of the configuration, the second hinge acts as the ground in the first dipole antenna, and the first hinge unit acts as the power feed system in the second dipole antenna. Therefore, the thickness and size of the enclosures can simultaneously be reduced. Further, the portable radio has a radiation characteristic in which principal polarized wave components of the two antennas intersect at right angles, and hence can exhibit high communication performance.

It is also preferable that the first matching circuit should have one end electrically connected to the antenna element and another end for feeding electric power from the first radio circuit of the second circuit board; that a second matching circuit should have one end electrically connected to the 20 second hinge unit and another end electrically connected to the second radio circuit of the second circuit board; that the first radio circuit should conform to a first frequency that is an operating frequency of the first antenna; and that the second radio circuit should conform to a second frequency that is an operating frequency of the second antenna. By means of the configuration, the portable radio can exhibit, by use of different frequencies, a superior antenna characteristic in which the principal polarized wave components of the two antennas intersect at right angles.

There may also be arranged in such a way that the portable radio further includes a first filter and a second filter that shut off a resonance frequency of the first antenna and a third filter that shuts off a resonance frequency of the second antenna; that the first filter has one end electrically connected to the first hinge unit and another end connected to the third hinge unit; that the second filter is placed on the second circuit board and has one end electrically connected to the second hinge unit and another end electrically connected to the second matching circuit of the second circuit board; and that the third filter has one end electrically connected to the first hinge unit and another end electrically connected to the first matching circuit. The configuration can prevent flow of a signal of the dipole antenna in the hinge from flowing to the circuit boards in the first and second enclosures that act as a portion of the other dipole antenna. Therefore, the two antennas can simultaneously operate by use of different frequencies and also exhibit superior antenna characteristics in which their principal polarized wave components intersect at right angles.

There may also be arranged in such a way that the power feed unit is electrically connected to the radio circuit placed on the first or second circuit board by way of a coaxial line; and that an exterior conductor of the coaxial line electrically connects the third hinge unit to a ground of the first or second circuit board. By means of the configuration, the second hinge acts as the ground in the first dipole antenna, and the first hinge unit acts as the power feed system in the second dipole antenna. Therefore, the thickness and size of the enclosures can simultaneously be reduced. Further, the portable radio has a radiation characteristic in which principal polarized wave components of the two antennas intersect at right angles, and hence can exhibit high communication performance.

There may also be arranged in such a way that the portable radio further includes a high frequency switch that is electrically connected to the second matching circuit and the power feed unit for switching between the first antenna and the second antenna. The configuration makes it possible to switch between a plurality of antennas having different polarized waves and exhibit high communication performance.

There may also be arranged in such a way that an overlap between the antenna element, the first hinge, and the second hinge in their longitudinal directions comes to about one-half of a length of the antenna element or less. The configuration lessens electromagnetic coupling among the antenna element, the first hinge, and the second hinge, so that deterioration of the communication characteristic can be prevented.

### <Advantage of the Invention>

In the portable radio of the present invention, the first hinge acts as the ground in the first dipole antenna and acts also as the power feed system in the second dipole antenna for feeding electric power from the second circuit board to the first circuit board. As a result, two dipole antennas having different polarized waves are realized, and the portable radio can exhibit high communication performance appropriate for its operating state despite its small size and low profile.

### BRIEF DESCRIPTION OF THE DRAWINGS

FIG. 1 is a front view showing a foldable portable phone of a first embodiment of the present invention.

FIG. 2 is an oblique perspective view showing a configuration of a first hinge of the first embodiment of the present invention.

FIGS. 3 (A) and (B) are descriptive views showing a radiation pattern of operation of a first dipole antenna of the first embodiment of the present invention and a manner of usage of the dipole antenna, and (C) and (D) they are descriptive views showing a radiation pattern of operation of a second dipole antenna of the first embodiment of the present invention and a manner of usage of the dipole antenna.

FIG. 4 is a front view showing a foldable portable phone of a second embodiment of the present invention.

FIG. 5 is a front view showing a foldable portable phone of a third embodiment of the present invention.

FIG. 6 is a front view of a biaxial foldable portable phone of a fourth embodiment of the present invention acquired when the phone is opened in a longitudinal direction.

FIGS. 7 (A) and (B) are a front view and a side view of the biaxial foldable portable phone of the fourth embodiment achieved when the phone is opened in a horizontal direction.

FIG. 8 (A) is an oblique perspective view showing a configuration of a second hinge of the fourth embodiment of the present invention, and (B) is an oblique perspective view showing a turning state of the hinge.

FIG. 9 is a front view showing a foldable portable phone of a fifth embodiment of the present invention.

FIG. 10 is a plan view showing a configuration of a related art foldable portable phone.

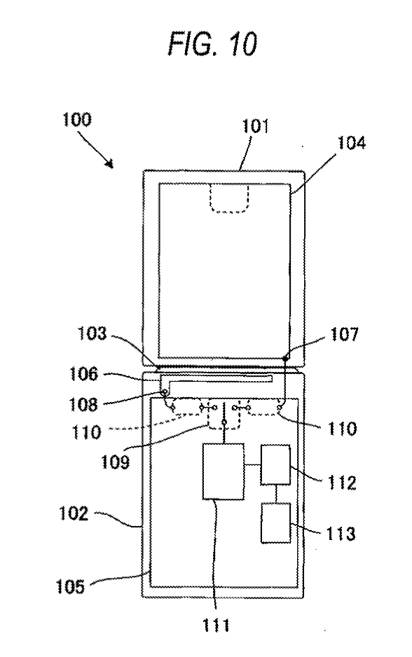

FIG. 11 is an oblique perspective view showing a configuration of another related art foldable portable phone.

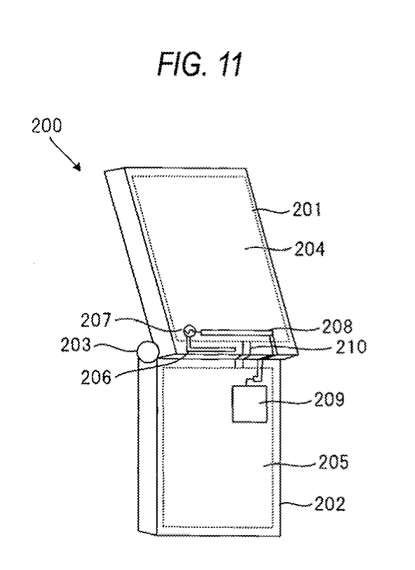

### DESCRIPTIONS OF THE REFERENCE NUMERALS AND SYMBOLS

10, 20, 30, 40, 50 FOLDABLE PORTABLE PHONE
11 UPPER ENCLOSURE (FIRST ENCLOSURE)
11A FIRST CIRCUIT BOARD (UPPER CIRCUIT BOARD)
12 LOWER ENCLOSURE (SECOND ENCLOSURE)
12A SECOND CIRCUIT BOARD (LOWER CIRCUIT BOARD)
13 HINGE
13A HINGE ELEMENT (FIRST HINGE; FIRST HINGE ELEMENT)
130 FIRST JOINT UNIT
131 HINGE FIXING UNIT (SECOND HINGE UNIT)
132 HINGE ROTATING UNIT (FIRST HINGE UNIT)
13B HINGE ELEMENT (SECOND HINGE; SECOND HINGE ELEMENT)
134 GROUND
135 HINGE FIXING UNIT (THIRD HINGE UNIT)
136 HINGE ROTATING UNIT (FOURTH HINGE UNIT)
137 SECOND JOINT UNIT
14 ANTENNA ELEMENT
15 POWER FEED UNIT
16A, 16B, 42, 61 IMPEDANCE MATCHING CIRCUIT
17A, 17B, 31, 43, 62 RADIO CIRCUIT
18 COAXIAL LINE
21A, 72 FIRST FILTER
21B, 71 SECOND FILTER
21C, 73 THIRD FILTER
32 HIGH FREQUENCY SWITCH

### BEST MODES FOR IMPLEMENTING THE INVENTION

Preferred embodiments of the present invention are below described in detail by reference to the drawings.

### First Embodiment

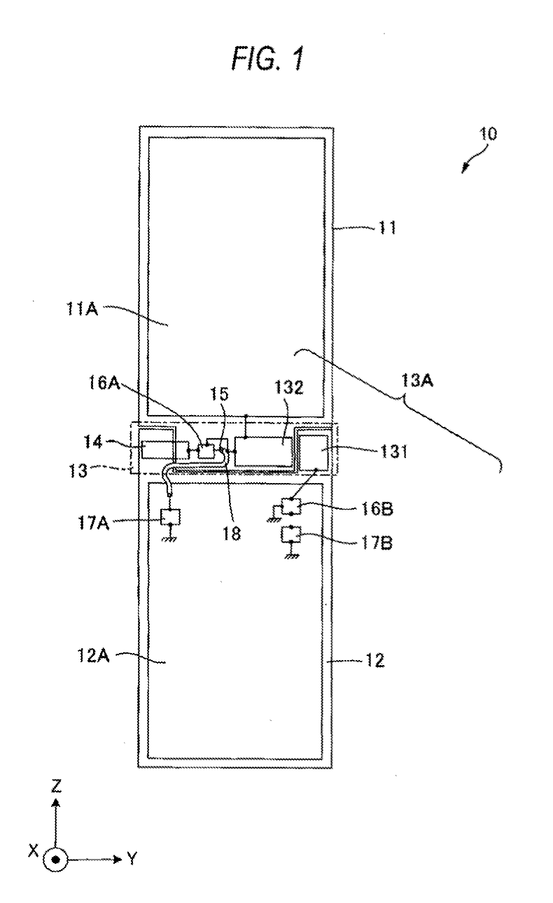

FIG. 1 shows a foldable portable phone 10 of a first embodiment of a portable radio of the present invention. The foldable portable phone 10 has an upper enclosure 11 making up a first enclosure; a lower enclosure 12 making up a second enclosure; a hinge 13 that joins the upper enclosure 11 to the lower enclosure 12 in a rotatable manner; an antenna element 14; a first impedance matching circuit 16A and a second impedance matching circuit 16B; a first radio circuit 17A and a second radio circuit 17B; and a coaxial line 18.

The upper enclosure 11 has an un-illustrated display unit and a first circuit board (an upper circuit board) 11A. The lower enclosure 12 has an un-illustrated operation unit, a second circuit board (a lower circuit board) 12A, the foregoing second impedance matching circuit 16B, the foregoing first radio circuit 17A, and the foregoing second radio circuit 17B.

The hinge 13 has a hinge element 13A making up a first hinge, the foregoing antenna element 14, and the foregoing first impedance matching circuit 16A. Although details will be described later, the antenna element 14, the first impedance matching circuit 16A, a ground 134, a spring connector 134C, and the like, are placed on a substrate 133 in the hinge 13 of the present embodiment.

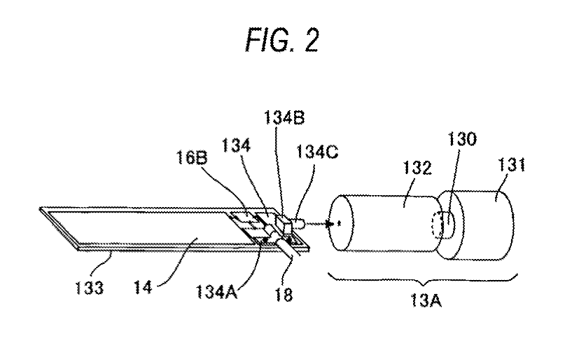

The hinge element 13A joins the upper enclosure 11 to the lower enclosure 12 in a rotatable manner. As shown in FIG. 2, the hinge element 13A has a hinge fixing unit 131 making up a second hinge unit; a hinge rotating unit 132 that is attached to the hinge fixing unit 131 in a rortatable manner and that makes up a first hinge unit; and a first joint unit 130 that electrically connects the hinge fixing unit 131 to the hinge rotating unit 132 and also supports the same in a rotatable manner. All of the units of the hinge element are made of a conductive material.

The hinge fixing unit 131 is fixed to the lower enclosure 12. In the meantime, the hinge rotating unit 132 is fixed to the upper enclosure 11.

The substrate 133 is provided in the hinge 13 along the direction of a rotational axis and is formed from; for instance, an FPC (Flexible Printed Board), or the like.

As shown in FIG. 2, the ground 134 is formed from a conductor (e.g., copper foil) placed on the substrate 133. A coaxial line fixing unit 134A and a spring connector fixing unit 134B each of which is formed from a conductive material are fixedly placed on and electrically connected to the ground.

One end (an exterior conductor) of the coaxial line 18 is fixed to the coaxial line fixing unit 134A. In order to establish an electrical connection with the hinge element 13A while holding a freely-rotatable state with respect to the hinge rotating unit 132, an end of the spring connector 134C is fastened to the spring connector fixing unit 134B. Therefore, a ground of the lower circuit board 12A, the ground 134, and the hinge element 13A are electrically connected together. The antenna element 14 is electrically connected to the first radio circuit 17A by way of the first impedance matching circuit 16A and an interior conductor of the coaxial line 18. A contact point between the interior conductor of the coaxial line 18 and the first matching circuit is taken as a power feed unit 15.

The antenna element 14 is placed substantially in parallel with the axial direction of the hinge element 13A. As shown in FIG. 2, the antenna element 14 of the present embodiment is formed on the substrate 133 and has an electrical length, in a direction parallel to a rotating axis of the hinge 13, that is about a quarter of a wavelength λ corresponding to an operating frequency (f1) of a first dipole antenna.

The second impedance matching circuit 16B matches impedance of a ground of the upper circuit board 11A and impedance of the hinge 13 to be connected to 50 ohms at an operating frequency (f2) of the second radio circuit 17B. In the meantime, the first impedance matching circuit 16A matches impedance of the antenna element 14 to 50 ohms at the operating frequency (f1) of the first radio circuit 17A.

The coaxial line 18 has the exterior conductor and the interior conductor neither of which is illustrated. One end of the exterior conductor is secured to the coaxial line fixing unit 134A (see FIG. 2), and another end of the exterior conductor is connected to the ground of the lower circuit board 12A. Specifically, the ground 134 is connected to the ground of the lower circuit board 12A. In consideration of prevention of leakage of a radio wave, it is desirable to form the coaxial line 18 to a length that is about a quarter of a wavelength λ2 corresponding to an operating frequency (f2) of the first dipole antenna made up of the antenna element 14 and the hinge element 13A.

One end of the interior conductor of the coaxial line 18 is connected to the antenna element 14 by way of the first impedance matching circuit 16A, and another end of the same is connected to the first radio circuit 17A. Specifically, the antenna element 14 is electrically connected to the first radio circuit 17A by way of the first impedance matching circuit 16A.

In the present embodiment, the antenna element 14 and the hinge element 13A configure the first dipole antenna that produces resonance at the operating frequency f1. The hinge element 13A acts as a ground in the first dipole antenna at the operating frequency f1.

A ground pattern on the upper circuit board 11A and a ground pattern on the lower circuit board 12A configure a second dipole antenna that produces resonance at an operating frequency f2. The hinge element 13A makes up a power feed system at the operating frequency f2.

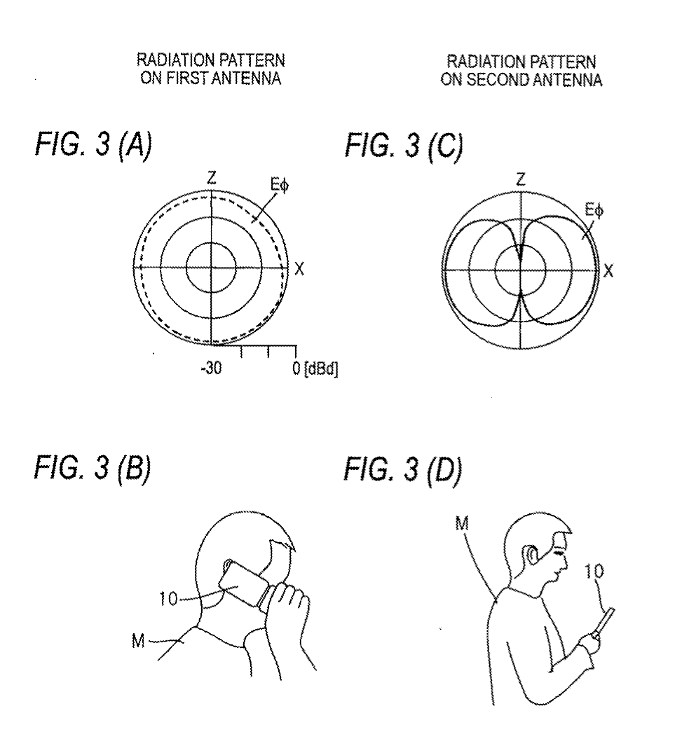

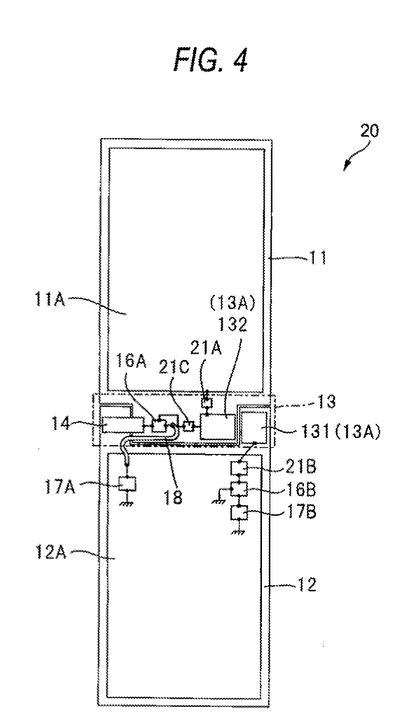

Operation performed in the present embodiment is now described by reference to FIGS. 3 and 4.

(I) About the First Dipole Antenna:

The first dipole antenna feeds electric power from the first radio circuit 17A to the antenna element 14 by way of the coaxial cable 18. Since the antenna element 14 and the hinge rotating unit 132 are connected together, the antenna element 14 and the hinge element 13A operate as a dipole antenna. For instance, the dipole antenna is assumed to be a 2 GHz-band communication antenna, an antenna element is given a length of 20 mm, and the hinge element 13A is given a length of 20 mm. The antenna operates as a half-wavelength dipole at a 2 GHz band. Therefore, in a radiation pattern appearing in an XZ plane shown in FIG. 3(A), a predominant polarized wave acts as a horizontal polarized wave component, and a substantially non-directional characteristic is obtained.

In the case of a phone call, a user M tends to use the portable phone 10 at an inclination as shown in FIG. 3(B). Therefore, a vertically polarized wave component increases, so that the thus-increased vertical polarized wave component matches a vertical polarized wave that is a principal polarized wave component of the communication base station, so that communication performance can be enhanced.

(II) About the Second Dipole Antenna:

In the second dipole antenna, the upper enclosure board 11A and the lower enclosure board 12A operate as the second dipole antenna that takes the hinge element 13A as a power feed system. Accordingly, if the dipole antenna is taken as; for instance, a DTV (digital television) antenna, the principal polarized wave will act as the vertical polarized wave component in a radiation pattern appearing in an XZ plane shown in FIG. 3(C) on condition that the length of the upper and, lower boards is 90 mm, so that a characteristic assuming the shape of the infinity symbol is yielded.

When a TV program is watched, the user M tends to use the portable phone 10 at an inclination as shown in FIG. 3(D). Therefore, the horizontal polarized wave component increases, to thus match a horizontal polarized wave that is the principal polarized wave component of the TV broadcast station. Hence, receiving sensitivity of the television can be enhanced.

Accordingly, in the present embodiment, the first hinge element 13A that is the ground of the antenna element 14 making up the first dipole antenna is placed in the hinge 13. Further, the first hinge element 13A is shared by the power feed system in the second dipole antenna, whereby the antenna configuration can be realized in the nominal space required for the hinge 13. Therefore, the embodiment is effective for reducing a thickness and size of the portable phone 10. Specifically, antenna space is not required in the upper enclosure 11 and the lower enclosure 12. Hence, compact enclosures can be realized. Further, an antenna portion does not protrude out of the enclosures, and hence impairment of an appearance of the portable phone can be avoided.

Further, according to the present embodiment, the principal polarized wave component of the first dipole antenna and the principal polarized wave component of the second dipole antenna differ from each other, and hence the dipole antennas can simultaneously operate as two antennas having different polarized waves.

An overlap between the antenna element 14 and the first hinge element 13A achieved in the longitudinal direction may also be set to about one-half of the length of the antenna element 14 or less. By means of the configuration, electromagnetic coupling between the antenna element 14 and the first hinge element 13A becomes smaller, and deterioration of the communication characteristic can be prevented.

### Second Embodiment

A second embodiment of the present invention is now described in detail by reference to FIG. 4. In the present embodiment, elements that are the same as those described in connection with the first embodiment are assigned the same reference numerals, and their repeated explanations are omitted here for brevity.

In addition to including the upper enclosure 11, the lower enclosure 12, the hinge 13, the antenna element 14, the first impedance matching circuit 16A, the second impedance matching circuit 16B, the first radio circuit 17A, the second radio circuit 17B, and the coaxial line 18, a foldable portable phone 20 of the present embodiment includes a first filter 21A, a second filter 21B, and a third filter 21C.

When the first dipole antenna made up of the antenna element 14 and the hinge element 13A of the first embodiment operates at the frequency f1 (a first frequency), the hinge element 13A is shared by a power feed system of the frequency f2 (a second frequency). Consequently, the third filter 21C hinders a high frequency current of the frequency f2 from flowing from the hinge element 13A to the antenna element 14.

When the second dipole antenna, which is configured such that the upper enclosure board 11A and the lower enclosure board 12A of the first embodiment employ the hinge element 13A as a power feed system, operates at the frequency f2 (the second frequency), the hinge element 13A is shared by the ground of the frequency f1. Hence, the first filter 21A hinders the high frequency current of the frequency f1 from flowing from the antenna element 14 to the upper circuit board 11A. Further, the second filter 21B hinders a high frequency current of the frequency f1 from flowing from the antenna element 14 to the lower circuit board 12A.

As mentioned above, in the present embodiment, the antenna element 14 and the hinge element 13A operate as the first dipole antenna at the frequency (f1). Alternatively, when the upper enclosure board 11A and the lower enclosure board 12A operate, at the frequency (f2), as the second dipole antenna that employs the hinge element 13A as a power feed system, deterioration of the antenna characteristic, which will be caused by electromagnetic coupling of the dipole antenna with another antenna, is eliminated as much as possible. Further stable communication performance can be implemented.

In the present embodiment, both the first filter 21A and the second filter 216 are disposed. However, there may also be adopted a configuration in which only one of the first filter and the second filter is disposed.

In the present embodiment, the third filter 21C is disposed. However, when the filters are not required, the third filter may also be deleted.

### Third Embodiment

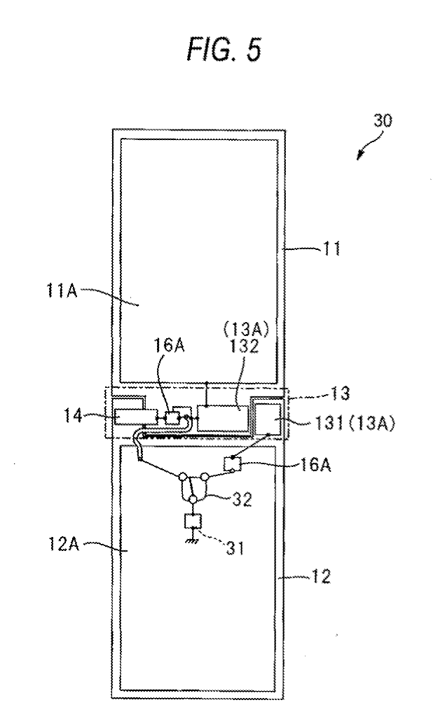

A third embodiment of the present invention is described in detail by reference to FIG. 5. In the present embodiment, elements that are the same as those described in connection with the first embodiment are assigned the same reference numerals, and their repeated explanations are omitted here for brevity.

Unlike the foldable portable phone of the first embodiment, a foldable portable phone 30 of the present embodiment has a single radio circuit 31 in place of the first radio circuit 17A and the second radio circuit 17B. The portable phone also has a high frequency switch 32 for switching circuitry between the radio circuit 31 and the first impedance matching circuit 16A, the second impedance matching circuit 16B.

The radio circuit 31 switches the circuitry by means of the high frequency switch 32, thereby doubling as radio circuits for the second dipole antenna and the first dipole antenna. The second dipole antenna and the first dipole antenna are structurally identical, except the radio circuit 31, with their counterparts described in connection with the first embodiment.

The high frequency switch 32 performs switching among antennas of multiple systems according to; for instance, an operating state, by use of a radio circuit of one system, to thus selectively use any one of the antennas.

Accordingly, according to the present embodiment, the first dipole antenna differs from the second dipole antenna in terms of the principal polarized wave component. Namely, the principal polarized wave of the first dipole antenna is a horizontally polarized wave component, and the principal polarized wave of the second dipole antenna is a vertically polarized wave component. Hence, a diversity antenna having different polarized waves can be implemented in the nominal space required for the hinge 13 by means of switching between the dipole antennas that is performed by the high frequency switch 32. Therefore, the configuration lends itself to reducing the thickness and size of the foldable portable phone 30.

### Fourth Embodiment

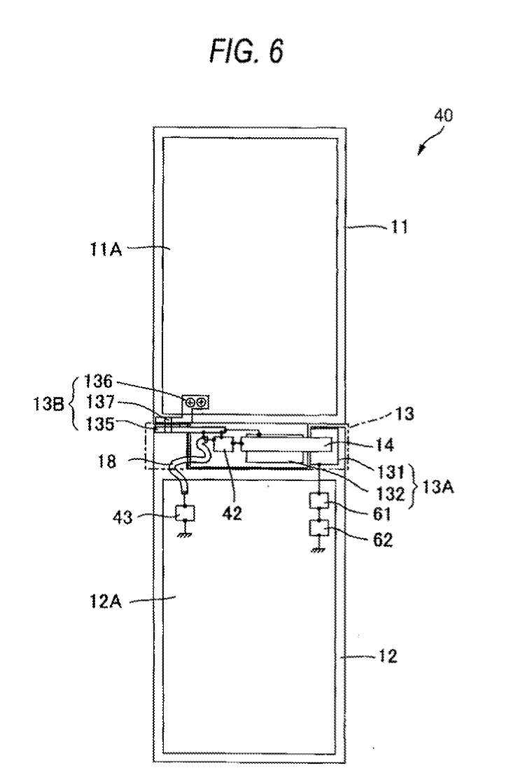

A fourth embodiment of the present invention is now described in detail by reference to FIGS. 6 through 8. In the present embodiment, elements that are the same as those described in connection with the first embodiment are assigned the same reference numerals, and their repeated explanations are omitted here for brevity.

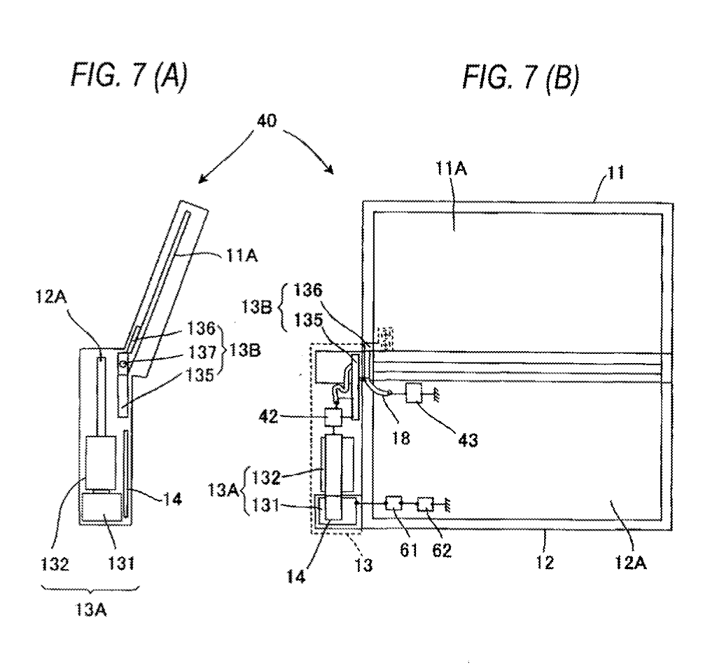

In a foldable portable phone 40 of the present embodiment in contrast to the foldable portable phones described in connection with the first through third embodiments, the upper enclosure 11 and the lower enclosure 12 configure a biaxial foldable portable phone that can reclosably open in a horizontal direction (a sideway direction) shown in FIG. 7 as well as in a vertical direction (a longitudinal direction) shown in FIG. 6.

Accordingly, in addition to including the upper enclosure 11, the lower enclosure 12, a hinge 13, a first impedance matching circuit 42, a second impedance matching circuit 61, a first radio circuit 43, a second radio circuit 62, the antenna element 14, and the vertical-open hinge element (herein after called a “first hinge element”) 13A, the foldable portable phone 40 of the present embodiment has a hinge element 13B making up a horizontal open second hinge (hereinafter called a “second hinge element”).

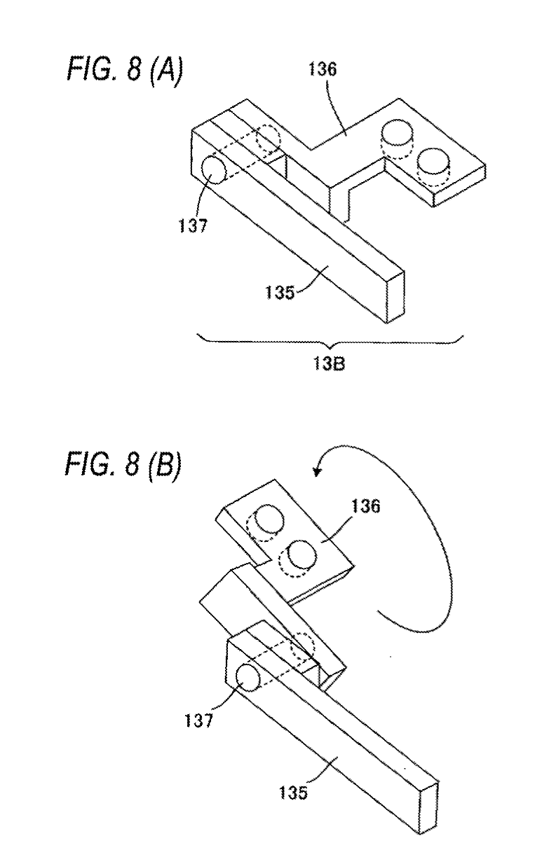

As shown in FIG. 8, the second hinge element 13B has a hinge fixing unit 135 that makes up a third hinge unit and a hinge rotating unit 136 that makes up a fourth hinge unit capable of rotating in a horizontal direction around a rotational axis 137 which makes up a second joint unit with respect to the hinge fixing unit 135. The hinge fixing unit 135 is fixed to the hinge 11, and the hinge rotating unit 137 is fixed to the upper enclosure 135. The rotational axis 136 makes up an axis that lets the upper enclosure 11 and the lower enclosure 12 relatively rotate along a direction orthogonal to a rotational axis of the hinge element 13A, whereby the hinge fixing unit 135 and the hinge rotating unit 136 are joined in a rotatable manner. The hinge fixing unit 135, the rotational axis 137, and the hinge rotating unit 136 each are made of a conductive material. Units from the hinge fixing unit 135 to the hinge rotating unit 136 are electrically connected.

As shown in FIGS. 6 and 7, the second hinge element 13B (the hinge fixing unit 135) and the antenna element 14 are connected together by means of the impedance matching circuit 42, and the hinge fixing unit 135 and the ground of the lower circuit board 12A are connected together by means of the exterior conductor of the coaxial line 18. The first radio circuit 43 of the lower circuit board 12A and the first impedance matching circuit 42 are connected together by means of an interior conductor of the coaxial line 18. The second hinge element 13B and the antenna element 14 operate as a dipole antenna (a first dipole antenna) that produces resonance at the frequency f1.

The first impedance matching circuit 42 matches impedance of the antenna element 14 to 50 ohms at the operating frequency (f1) of the first radio circuit 43.

The hinge fixing unit 135 of the second hinge element 13B and the hinge rotating unit 132 of the first hinge element 13A are electrically connected, and the hinge fixing unit 131 of the first hinge element 13A is connected to the second impedance matching circuit 61. The second impedance circuit 61 is connected to the second radio circuit 62 on the lower circuit board 12A. The hinge fixing unit 135 of the second hinge element 13B is electrically connected to the upper circuit board 11A of the upper enclosure 11.

Consequently, the ground pattern of the upper circuit board 11A and the ground pattern of the lower circuit board 12A configure a second dipole antenna that produces resonance at the operating frequency f2. In this case, the second hinge element B and the first hinge element A operate as a power feed system.

The antenna element 14 is placed in substantially parallel to the hinge fixing unit 135 of the second hinge element 13B in the hinge unit on the upper enclosure 11 making up a portion of the hinge 13.

Accordingly, in the present embodiment employing the biaxial hinge configuration, the second hinge element 13B that is the ground of the antenna element 14 making up the first dipole antenna is placed in the hinge 13. Moreover, the second hinge element is shared by the power feed system in the second dipole antenna, whereby the antenna configuration can be implemented in the nominal space required for the hinge 13. Therefore, the hinge configuration is effective for reducing the thickness and size of the portable phone 10. Specifically, antenna space is not required in the upper enclosure 11 and the lower enclosure 12. Hence, compact enclosures can be implemented, and the antenna portion does not need to protrude out of the enclosures. Therefore, impairment of an appearance of the portable radio can be avoided.

Accordingly, in the present embodiment, one antenna component; namely, a single antenna element 14, enables performance of multiband operation. When the foregoing two dipole antennas are caused to operate at a single frequency (f1=f2), the polarized waves of the antennas intersect at right angles, so that a polarized wave diversity effect is yielded. The direction of the polarized wave of the second dipole antenna intersects the direction of the polarized wave of the first dipole antenna at right angles. Hence, for instance, if the first dipole antenna is used for a DTV purpose (a horizontal polarized wave is realized in a viewing state) and if the second dipole antenna is used for a cellular phone purpose (a vertical polarized wave is realized during a phone call), a multi-antenna function exhibiting a superior antenna characteristic is provided; hence, convenience is provided.

An overlap among the antenna element 14, the first hinge element 13A, and the second hinge element 136 in their longitudinal directions can also be set to about one-half of the length of the antenna element 14 or less. Electromagnetic coupling among the antenna element 14, the first hinge element 13A, and the second hinge element 13B is reduced by the configuration, so that deterioration of the communication characteristic can be prevented.

### Fifth Embodiment

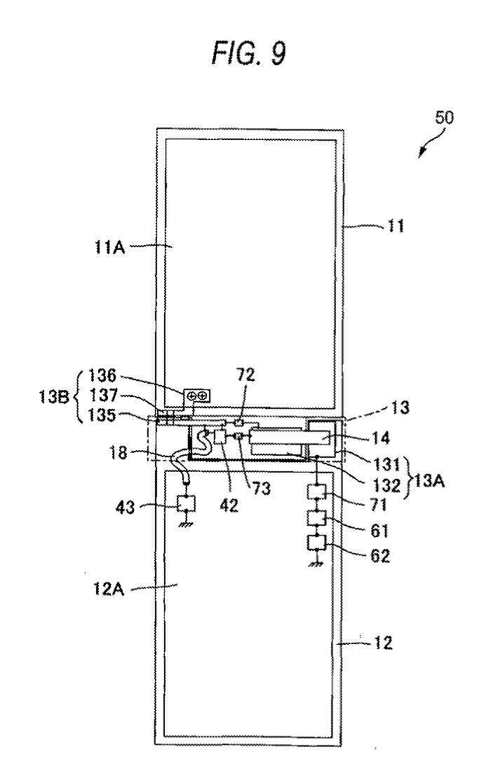

A fifth embodiment of the present invention is now described in detail by reference to FIG. 9. In the embodiment, elements that are the same as those described in connection with the fourth embodiment are assigned the same reference numerals, and their repeated explanations are omitted here for brevity.

A foldable portable phone 50 of the present embodiment differs from its counterpart described in connection with the fourth embodiment in that a first filter 71 is interposed between the impedance matching circuit 61 and the first hinge element 13A; that a second filter 72 is placed on a connection line between the first hinge element 13A and the second hinge element 13B; and that a third filter 73 is interposed between the hinge fixing unit 135 of the second hinge element B and the first matching circuit 42.

The first filter 71, the second filter 72, and the third filter 73 are intended for preventing deterioration of the antenna characteristic, which would otherwise be caused by coupling between the first dipole antenna and the second dipole antenna and act as a high frequency filter.

Specifically, the first filter 71 is joined to the first hinge located in close proximity to the first dipole antenna, thereby hindering flow of the high frequency current f1, which originates from the first hinge element 13A, to the lower circuit board 12A.

Likewise, the second filter 72 is also joined to the first hinge located in close proximity to the first dipole antenna, thereby preventing flow of the high frequency current f1, which originates from the first hinge element 13A, to the upper circuit board 11A.

The third filter 73 prevents flow. of the high frequency current f2 of the second dipole antenna from the second hinge element B to the antenna , element 14.

Consequently, according to the present embodiment, deterioration of a characteristic, which would otherwise be caused by coupling between the first dipole antenna and the second dipole antenna, can be lessened.

The present invention is not limited to the aforementioned embodiments at all and can be practiced in various forms without departing the range of the gist of the invention.

Although the present invention has been described in detail by reference to the specific embodiments, it is manifest to those skilled in the art that the present invention is susceptible to various alterations or modifications without departing the spirit and scope of the present invention.

The present patent application is based on Japanese Patent Application No. 2008-157855 filed on Jun. 17, 2008, the entire subject matter of which is incorporated herein by reference.

### INDUSTRIAL APPLICABILITY

The portable radio of the present invention enables simultaneous reduction of a thickness and a size of enclosures and also yields an advantage of the ability to exhibit high phone call performance; and hence, the portable radio is useful as; for instance, a foldable portable phone, or the like.

1. A portable radio, comprising:
a first enclosure in which a first circuit board is placed;
a second enclosure in which a second circuit board is placed;
a first hinge that rotatably joins the first enclosure to the second enclosure and that includes a conductive characteristic;
an antenna element that is placed in a vicinity of the first hinge and substantially in parallel to an axial direction of the first hinge;
a first radio circuit and a second radio circuit placed on the second circuit board; and
a power feed unit connected to the first radio circuit,
wherein the antenna element is placed while spaced apart from the first hinge by a predetermined interval and is electrically connected to the power feed unit;
the first hinge has a first hinge unit and a second hinge unit and a first joint unit that electrically connects the first hinge unit to the second hinge unit and that support the first hinge unit and the second hinge unit in a rotatable manner;
the first hinge unit is provided in the first enclosure and electrically connected to an end of the first circuit board that is close to the first hinge;
the second hinge unit is provided in the second enclosure and is placed while spaced apart from a ground pattern on the second circuit board by a predetermined interval and is electrically connected to the second radio circuit;
the antenna element and the first hinge configure a first dipole antenna, and a ground pattern on the first circuit board, the first hinge, and the ground pattern on the second circuit board configure a second dipole antenna; and
the first hinge is a ground in the first dipole antenna and acts as a power feed system in the second dipole antenna feeding electric power from the second circuit board to the first circuit board.

2. The portable radio according to claim 1, further comprising:
a first matching circuit that effects impedance matching placed between the antenna element and the power feed unit;
wherein a ground of the first matching circuit is electrically connected to the first hinge.

3. The portable radio according to claim 2, wherein:
the first matching circuit has one end electrically connected to the antenna element and another end connected to a power feed unit that feeds electric power from the first radio circuit of the second circuit board;
a second matching circuit has one end electrically connected to the second hinge unit and another end electrically connected to the second radio circuit of the second circuit board;
the first radio circuit conforms to a first frequency that is an operating frequency of a first antenna; and
the second radio circuit conforms to a second frequency that is an operating frequency of a second antenna.

4. The portable radio according to claim 3, further comprising:
at least one of a first filter and a second filter that shuts off a resonance frequency of the first antenna and a third filter that shuts off a resonance frequency of the second antenna;
wherein the first filter has one end electrically connected to the first hinge unit and another end electrically connected to an end of the first circuit board that is close to the first hinge;
the second filter is placed on the second circuit board and has one end electrically connected to the second hinge unit and another end electrically connected to the second matching circuit of the second circuit board; and
the third filter has one end electrically connected to the first hinge unit and another end electrically connected to the first matching circuit.

5. The portable radio according to claim 3, wherein:
the power feed unit is electrically connected to the radio circuit placed on either the first circuit board or the second circuit board by way of a coaxial line; and
an exterior conductor of the coaxial line electrically connects the first hinge unit to a ground of the first or second circuit board.

6. The portable radio according to claim 3, further comprising:
a high frequency switch that is electrically connected to the second matching circuit and the power feed unit for switching between the first antenna and the second antenna.

7. The portable radio according to claim 1, wherein an overlap between the antenna element and the first hinge in their longitudinal directions is about one-half of a length of the antenna element or less.

8. A portable radio comprising:
a first enclosure;
a second enclosure;
a first hinge; and
a second hinge that joins the first enclosure to the second enclosure so as to be rotatable around another axis orthogonal to an axis of the first hinge and that exhibits an electrical conductive characteristic,
wherein an antenna element is placed while spaced apart from the first hinge by a predetermined interval and electrically connected to a power feed unit;
the second hinge has a third hinge unit, a fourth hinge unit, and a second joint unit that electrically connects the third hinge unit to the fourth hinge unit and that supports the third hinge unit and the fourth hinge unit in a rotatable manner;
a first hinge unit is placed in the first enclosure and connected to the third hinge unit, and the fourth hinge unit is electrically connected to an end of a first circuit board that is close to the first hinge;
a second hinge unit is placed in the second enclosure while spaced apart from a ground pattern on a second circuit board by a predetermined interval and electrically connected to a second radio circuit;
the antenna element and the second hinge configure a first dipole antenna, a ground pattern of the first circuit board, the first hinge, the second hinge, and the ground pattern on the second circuit board configure a second dipole antenna; and
the second hinge acts as a ground in the first antenna and acts as, in the second antenna, a power feed system for feeding electric power from the second circuit board to the first circuit board.

9. The portable radio according to claim 8, further comprising:
a first matching circuit that is interposed between the antenna element and the power feed unit for matching impedance;
wherein a ground of the first matching circuit and the second hinge are electrically connected together.

10. The portable radio according to claim 9, wherein the first matching circuit has one end electrically connected to the antenna element and another end for feeding electric power from a first radio circuit of the second circuit board;
a second matching circuit has one end electrically connected to the second hinge unit and another end electrically connected to the second radio circuit of the second circuit board;
the first radio circuit conforms to a first frequency that is an operating frequency of the first antenna; and
the second radio circuit conforms to a second frequency that is an operating frequency of the second antenna.

11. The portable radio according to claim 10, further comprising: a first filter and a second filter that shut off a resonance frequency of the first antenna and a third filter that shuts off a resonance frequency of the second antenna;
the first filter has one end electrically connected to the first hinge unit and another end connected to the third hinge unit;
the second filter is placed on the second circuit board and has one end electrically connected to the second hinge unit and another end electrically connected to the second matching circuit of the second circuit board; and
the third filter has one end electrically connected to the first hinge unit and another end electrically connected to the first matching circuit.

12. The portable radio according to claim 11, wherein the power feed unit is electrically connected to the radio circuit placed on the first or second circuit board by way of a coaxial line; and an exterior conductor of the coaxial line electrically connects the third hinge unit to a ground of the first or second circuit board.

13. The portable radio according to claim 11, further comprising: a high frequency switch that is electrically connected to the second matching circuit and the power feed unit for switching between the first antenna and the second antenna.

14. The portable radio according to claim 8, wherein an overlap between the antenna element, the first hinge, and the second hinge in their longitudinal directions is about one-half of a length of the antenna element or less.
